(19) United States
(12) Patent Application Publication
(10) Pub. No.: US 2011/0314131 A1
(43) Pub. Date: Dec. 22, 2011

(54) Computer product, information management apparatus, and updating method

(75) Inventor: Masayuki Naito, Kawasaki (JP)

(73) Assignee: Fujitsu Limited of Kawasaki, Japan

(21) Appl. No.: 13/137,603

(22) Filed: Aug. 29, 2011

Related U.S. Application Data
(63) Continuation of application No. PCT/JP2009/055257, filed on Mar. 18, 2009.

(51) Int. Cl. G06F 15/16

(52) U.S. Cl. 709/219

(57) ABSTRACT

A computer-readable, non-transitory medium stores an updating program that causes a computer to execute a procedure. The computer has access to a database storing copy information that is for recovering software and correlated with a server in which the software is installed. The procedure includes receiving an update instruction for copy information of software installed in a first server; switch-controlling to disconnect a second server and a client terminal; extracting from the database, the copy information for which the update instruction is received; transmitting to the second server, the extracted copy information and an update instruction for the copy information, consequent to disconnection of the second server and the client server; receiving from the second server, the copy information updated at the second server, consequent to transmission of the update instruction; and registering to the database, the updated copy information, which has been correlated with the first server.

### CROSS REFERENCE TO THE RELATED APPLICATIONS

This application is a continuation application of International Application PCT/JP2009/055257, filed Mar. 18, 2009, and designating the U.S., the entire contents of which are incorporated herein by reference.

### FIELD

The embodiments discussed herein are related to information updating.

### BACKGROUND

Recently, networks for which stable operation 24 hours a day, 365 days a year is demanded have increased. Consequently, various types of technology for securing network system reliability have been provided (see, for example, Japanese Laid-Open Patent Publication Nos. 2006-99406 and 2001-211173).

Further, accompanying demands for continuously stable operation, there are occasions when the updating of software on the server (e.g., updating to the latest version) is performed without the need to restart the server and thus, without affecting service. On the other hand, with consideration of the possibility of hard disk damage, computer virus infection, etc., the software stored on the hard disk of the server must be backed up.

However, if software operating on the server is updated, differences arise between the updated software and the backed up software. Therefore, when the software on the server is updated, the backed up software must be updated. Typically, when software is backed up, the operation of all software has to be suspended. Therefore, when the software on the server is updated, the operation of all software is preferably suspended for safety.

However, in network systems of which continuously stable operation is demanded, the suspension of software operation is difficult. Thus, conventionally a method may be considered in which backed up software is updated using another server that is different from the server running the software.

However, with such an updating method of using another server, the same IP address is used between the server providing the service and running the original software and the server for updating. Consequently, a problem arises in that when a client uses the service, IP address collision may occur, impeding the service.

When software is distributed to the server for updating, the IP address set for the software may be changed. However, the IP address of the updated software at the server for updating has to be changed back to the original IP address and there is a risk that the IP address may be forgotten to be changed back to the original address or that the IP address is incorrectly changed.

Further, after software has been distributed to the server for updating, manual disconnection of the cable to make the network unavailable may be considered. However, a problem arises in that after the software has been distributed, it is necessary to make the network unavailable immediately, the timing of which is difficult. Further, at the time of software distribution, a problem arises in that since the network is available, IP addresses temporarily collide until the cable is disconnected. Furthermore, after the cable has been disconnected, update data cannot be distributed to the server through the network, arising in a problem in that recording media have to be used and manually carried.

### SUMMARY

According to an aspect of an embodiment, a computer-readable, non-transitory medium stores therein an updating program that causes a computer to execute a procedure. The computer has access to a database storing copy information that is for recovering software and correlated with a server in which the software is installed. The procedure includes receiving an update instruction for copy information of software installed in a first server that is among a group of servers; switch-controlling to disconnect a connection between a second server that is among the group of servers and a client terminal; extracting from the database, the copy information for which the update instruction is received at the receiving; transmitting to the second server, the extracted copy information and an update instruction for the extracted copy information, consequent to disconnection of the connection between the second server and the client server; receiving from the second server, the copy information updated at the second server, consequent to transmission of the update instruction at the transmitting; and registering to the database, the updated copy information, which has been correlated with the first server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram of a network system according to a first embodiment.

FIG. 2 is a diagram of an overview of the first embodiment.

FIG. 3 is a block diagram of a hardware configuration of an information management apparatus according to the first embodiment.

FIG. 4 is a diagram of an example of the contents of a management table.

FIG. 5 is a diagram of an example of the contents of a backup database.

FIG. 6 is a diagram of an example of the contents of a switch table.

FIG. 7 is a block diagram of a functional configuration of the information management apparatus according to the first embodiment.

FIG. 8 is a flowchart of an updating procedure performed by the information management apparatus according to the first embodiment.

FIG. 9 is system configuration diagram of the network system according to a second embodiment.

FIG. 10 is a diagram of an overview of the second embodiment.

FIG. 11 is a block diagram of a functional configuration of the information management apparatus according to the second embodiment.

FIG. 12 is a diagram of an address correspondence table.

FIG. 13 is flowchart of an updating procedure performed by the information management apparatus according to the second embodiment.

FIG. 14 is a sequence diagram of an example of a software updating procedure.

### DESCRIPTION OF EMBODIMENTS

Preferred embodiments of the present invention will be explained with reference to the accompanying drawings.

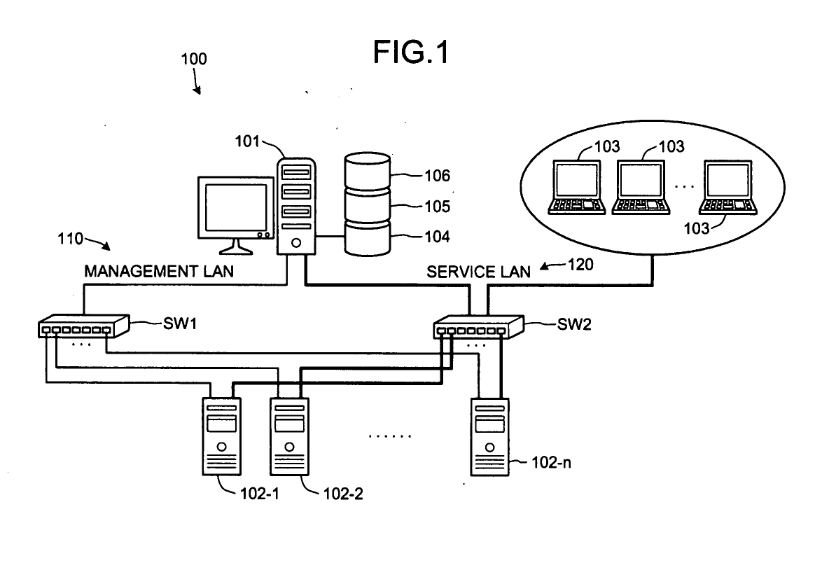

FIG. 1 is a system configuration diagram of a network system according to a first embodiment. As depicted in FIG. 1, a network system 100 includes an information management apparatus 101, servers 102-1 to 102-n, and a client terminal 103. In the network system 100, the information management apparatus 101, the servers 102-1 to 102-n, and the client terminal 103 are connected through a network such as a management local area network (LAN) 110, a service LAN 120, etc.

For example, the information management apparatus 101 and the servers 102-1 to 102-n can mutually communicate through a network switch SW1 of the management LAN 110. Further, the information management apparatus 101, the servers 102-1 to 102-n, and the client terminal 103 can mutually communicate through a network switch SW2 of the service LAN 120.

The management LAN 110 is a management network for managing the servers 102-1 to 102-n by the information management apparatus 101. The service LAN 120 is a service network for accessing the servers 102-1 to 102-n by the information management apparatus 101 and the client terminal 103.

In the network system 100, without placing the software used by the client on the client terminal 103 side, the software is collectively managed on the servers 102-1 to 102-n side. The client uses the client terminal 103 to access the servers 102-1 to 102-n, whereby the client can use the software installed in the servers 102-1 to 102-n to perform a service.

The information management apparatus 101 includes various types of databases 104 to 106 and has a function of managing backup images for restoring the software installed in the servers 102-1 to 102-n. The information management apparatus 101 has a further function of detecting and reporting failures and abnormalities of the servers 102-1 to 102-n to a manager of the network system 100.

The servers 102-1 to 102-n have a function of updating installed software to improve function, correct bugs, etc. The servers 102-1 to 102-n have a further function of updating software backup images in response to an update instruction from the information management apparatus 101.

The network switch SW1 has a function of relaying communication between the information management apparatus 101 and the servers 102-1 to 102-n and of connecting and disconnecting the servers 102-1 to 102-n connected to a port thereof. The network switch SW1 has a function of relaying communication between the information management apparatus 101, the servers 102-1 to 102-n and the client terminal 103 and of connecting and disconnecting the servers 102-1 to 102-n connected to a port thereof.

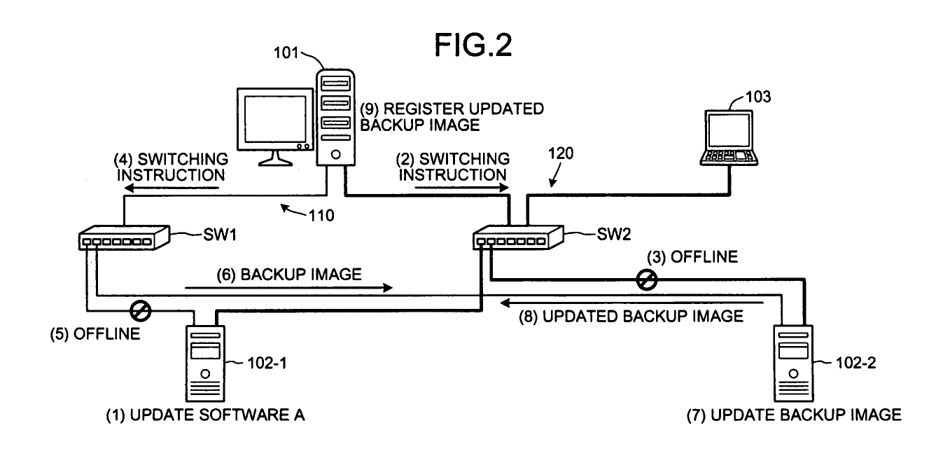

FIG. 2 is a diagram of an overview of the first embodiment. Here, it is assumed that the backup image of software A installed in the server 102-1 is updated using the server 102-2.

(1) The server 102-1 updates the running software A to the latest state. As a result, a difference arises between the updated software A and the backup image of the software A before updating. The software A is software that can be updated without suspending client service.

(2) Upon receiving an update instruction for the backup image of the software A, the information management apparatus 101 transmits to the network switch SW2, a switching instruction to switch the service LAN 120 connection port of the server 102-2, from online to offline.

(3) The network switch SW2 switches the service LAN 120 connection port of the server 102-2, from online to offline. As a result, access to the server 102-2 by the client terminal 103 becomes disabled.

(4) the information management apparatus 101 transmits to the network switch SW1, a switching instruction to switch the management LAN 110 connection port of the server 102-1, from online to offline.

(5) The network switch SW1 switches the management LAN 110 connection port of the server 102-1, from online to offline. As a result, access to the server 102-1 by the information management apparatus 101 becomes disabled.

(6) The information management apparatus 101 transmits the backup image of the software A to the server 102-2.

(7) Upon receiving a startup instruction from the information management apparatus 101, the server 102-2 updates the backup image of the software A to the newest state. At this time, since access to the server 102-2 by the client terminal 103 is restricted, collision with the software A running on the server 102-1 does not occur.

(8) The server 102-2 transmits to the information management apparatus 101, the updated backup image of the software A.

(9) The information management apparatus 101 registers the updated backup image of the software A to a backup DB 105. As a result, differences between the backup image of the software A and the software A installed in the server 102-1 are resolved.

In this manner, in the first embodiment, when the software A, which is running on the server 102-1, is updated, the backup image is updated and collected at the server 102-2, to which access from the client terminal 103 is restricted. Consequently, address collisions occurring at the time of backup image updating using the 2 servers 102-1, 102-2 is prevented, enabling backup to be performed safely.

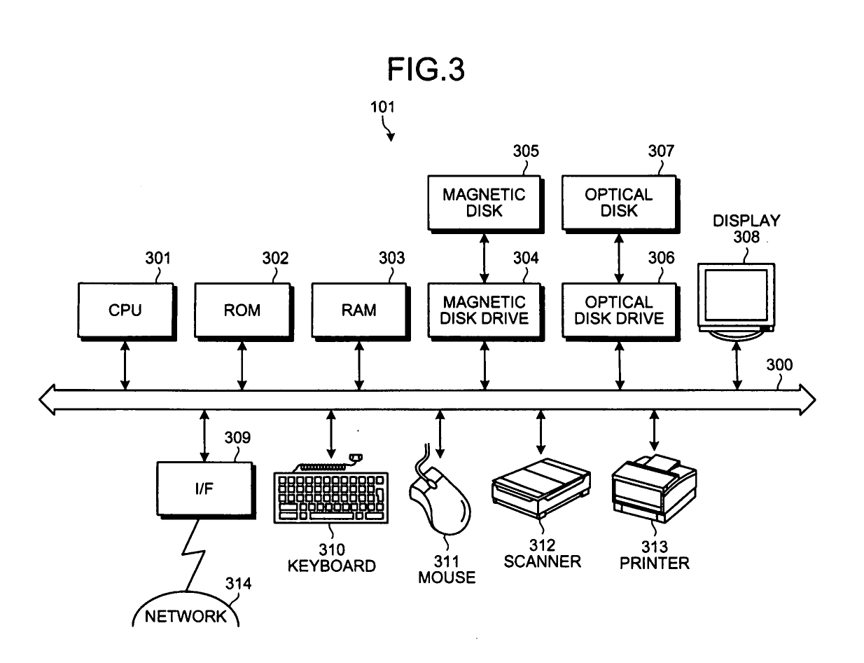

FIG. 3 is a block diagram of a hardware configuration of the information management apparatus according to the first embodiment. As depicted in FIG. 3, the information management apparatus 101 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 300.

The CPU 301 governs overall control of the design support apparatus. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as the management LAN 110, the service LAN 120, a wide area network (WAN), and the Internet through a communication line and is connected to other apparatuses through the network 314. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the design support apparatus. The scanner 312 may have an optical character reader (OCR) function as well. The printer 313 prints image data and text data. The printer 313 may be, for example, a laser printer or an ink jet printer.

Although a hardware configuration of the information management apparatus 101 has been described, the servers 102-1 to 102-n, the client terminal 103, and the network switches SW1, SW2 can be implemented by an identical hardware configuration.

Functions of the various types of databases 104 to 106 are implemented, for example, by storage devices such as the RAM 303, the magnetic disk 305, and the optical disk 307 of the information management apparatus 101 depicted in FIG. 3. Hereinafter, unless specified otherwise, “the servers 102-1 to 102-n” will be referred to as simply “the server(s) 102”.

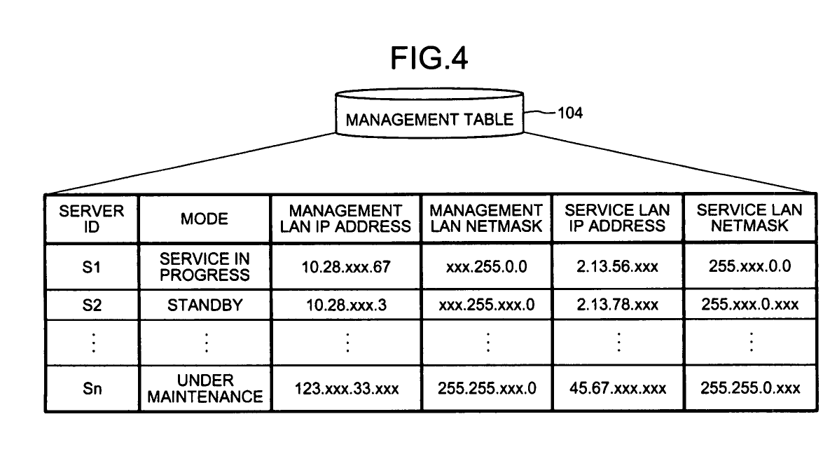

FIG. 4 is a diagram of an example of the contents of a management table. As depicted in FIG. 4, a management table 104 has fields that include server ID, mode, IP address of the management LAN, netmask of the management LAN, IP address of the service LAN, and the service LAN netmask. By entering information into each of the fields, management information for each of the servers 102 is stored as records.

A server ID is an identifier of the servers 102. A mode is an operation state of the servers 102. For example, “service in progress” is a mode during which software is being executed; “standby” is a mode during which the backup image of software can be updated; and “substituting” is a mode during which the backup image of software is being updated. Further, “under maintenance” indicates that inspection work is underway consequent to the occurrence of some problem.

The management LAN IP address is an IP address of the servers 102 and is used for communication on the management LAN 110. The management LAN netmask is a netmask of the servers 102 and is used for communication on the management LAN 110.

The service LAN IP address is an IP address of the servers 102 and is used for communication on the service LAN 120. The service LAN netmask is a netmask of the servers 102 and is used for communication on the service LAN 120.

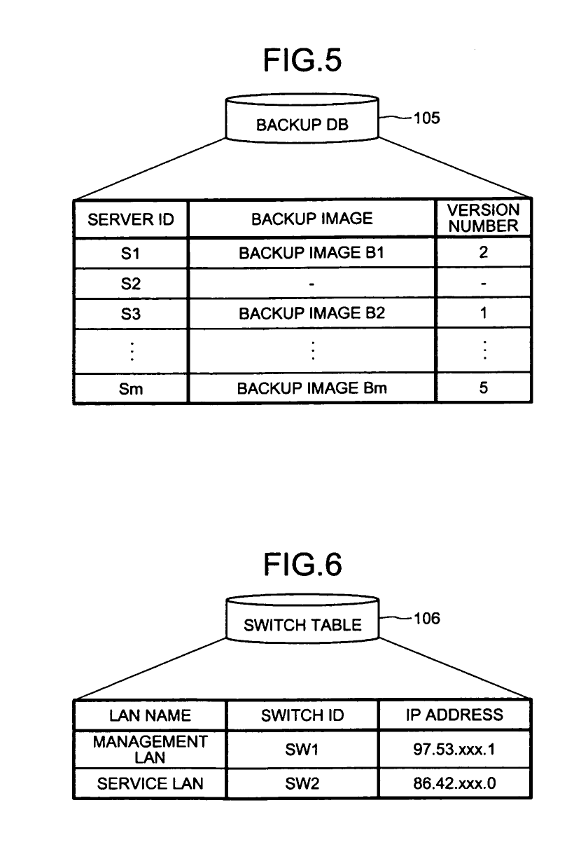

FIG. 5 is a diagram of an example of the contents of a backup database. As depicted in FIG. 5, the backup DB 105 has fields that include server ID, backup image, and version number. By entering information into each of the fields, backup images B1 to Bm for the client software can be stored as records.

A server ID is an identifier of the servers 102 in which the client software is installed. Backup image is copy information backing up the software as an image file. A version number is the number of times that that backup image of the software has been updated.

Backup image B1, for example, is copy information backing up, as an image file, software installed in the server 102-1; and the version number of which is “2”. For servers 102 in which no software is installed, in the backup image and version number fields, “−” (null) is entered.

FIG. 6 is a diagram of an example of the contents of a switch table. As depicted in FIG. 6, a switch table 106 has fields including LAN name, switch ID, and IP address. By entering information into each of the fields, information related to the network switches SW1, SW2 is stored as records.

A LAN name is the name of a LAN connected to a network switch. A switch ID is an identifier of a network switch. An IP address is the IP address of the network switch. Although not depicted, the switch table 106 may include login ID and login password fields for accessing the network switches SW1, SW2.

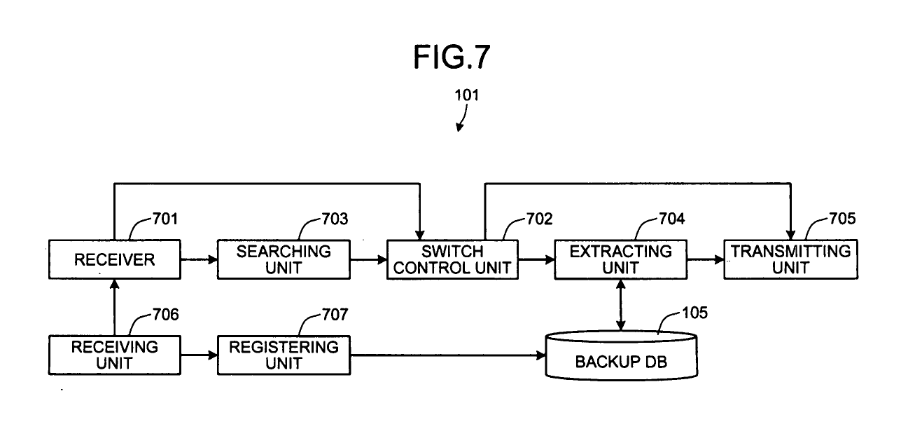

FIG. 7 is a block diagram of a functional configuration of the information management apparatus according to the first embodiment. The information management apparatus 101 includes a receiver 701, a switch control unit 702, a searching unit 703, an extracting unit 704, a transmitting unit 705, a receiving unit 706, and a registering unit 707. Functions forming this control unit (the receiver 701 to the registering unit 707), for example, are implemented by executing on the CPU 301, a program stored to a storage device such as the ROM 302, the RAM 303, the magnetic disk 305, the optical disk 307, etc. depicted in FIG. 3 or by the I/F 309.

The receiver 701 has a function of receiving an update instruction for a backup image Bk (k=1,2, . . . m) of software installed in a server 102-i (i=1,2, . . . n) among the servers 102-1 to 102-n. In this example, the server 102-i is a service server used for a client service. Software is an operating system (OS), middleware, an application, etc. necessary for implementing a client service. In this example, the software is particularly software that does not require restarting.

A backup image Bk is copy information for recovering software installed in the server 102-i. An update instruction for a backup image Bk includes, for example, the server ID “Si” of the server 102-i in which the software to be backed up is installed.

For example, the receiver 701 may receive an update instruction for a backup image Bk through user input via the keyboard 310, the mouse 311, etc. Further, the receiver 701 may receive an update instruction for the backup image Bk through the I/F 309, from an external computer apparatus. The results of reception are stored to a storage device such as the RAM 303, the magnetic disk 305, the optical disk 307, etc.

The switch control unit 702 has a function of disconnecting the connection between the client terminal 103 and a server 102-j (j=1,2, . . . , n, j≠i) that is among the servers 102-1 to 102-n and not the server 102-i. In this example, the server 102-j is an alternative server that performs, in place of the server 102-i, the backup of software that is running on the server 102-i.

For example, the switch control unit 702 refers to the switch table 106 depicted in FIG. 6 and identifies the IP address of the network switch SW2 on the service LAN 120. The network switch SW2 is a relay apparatus that relays communication between the server 102-j and the client terminal 103. Furthermore, the switch control unit 702 refers to the management table 104 and identifies the service LAN 120 IP address and netmask that correspond to the server ID “Sj” of the server 102-j.

The switch control unit 702 controls the transmitting unit 705 described hereinafter, uses the identified IP address of the network switch SW2, and transmits a switching instruction to disconnect the connection between the server 102-j and the client terminal 103. The switching instruction includes the identified service LAN 120 IP address and netmask of the server 102-j.

Consequently, at the network switch SW2, the service LAN 120 connection port for the server 102-j is switched from online to offline, disabling access to the server 102-2 by the client terminal 103. The results of the switching are stored to a storage device such as the RAM 303, the magnetic disk 305, the optical disk 307, etc.

The switch control unit 702 has a function of disconnecting the connection of the information management apparatus 101 and the server 102-i. For example, the switch control unit 702 refers to the switch table 106 and identifies the IP address of the network switch SW1 on the management LAN 110. The network switch SW1 is a relay apparatus that relays communication between the information management apparatus 101 and the server 102-j.

Furthermore, the switch control unit 702 refers to the management table 104 and identifies the management LAN 110 IP address and netmask that correspond to the server ID “Si” included in the update instruction for the backup image Bk. The switch control unit 702 controls the transmitting unit 705, uses the identified IP address of the network switch SW1, and transmits a switching instruction to disconnect the connection between the information management apparatus 101 and the server 102-i. The switching instruction includes the identified management LAN 110 IP address and netmask of the server 102-i.

Consequently, at the network switch SW1, the management LAN 110 connection port for the server 102-i is switched from online to offline, disabling access to the server 102-i by the information management apparatus 101.

The searching unit 703 has a function of searching among the servers 102-1 to 102-n for a server 102-j that can update software installed in the server 102-i. For example, the searching unit 703 refers to the management table 104 and searches for an arbitrary mode server 102-j that is in standby. Search results are stored to a storage device such as the RAM 303, the magnetic disk 305, the optical disk 307, etc.

In this example, the switch control unit 702 disconnects the connection between the retrieved server 102-j and the client terminal 103, whereby the server 102 being used for a client service and the server 102 performing backup can be excluded as the server 102-j to be the alternative server. If no server 102-j is retrieved, the information management apparatus may remain in standby until the operation state of any one of the servers 102 enters the standby mode.

The extracting unit 704 has a function of extracting from the backup DB 105, the backup image Bk of the software for which the update instruction was received. For example, the extracting unit 704 extracts from the backup DB 105, the backup image Bk that corresponds to the server ID “Si” included in the update instruction. Extraction results are stored to a storage device such as the RAM 303, the magnetic disk 305, the optical disk 307, etc.

The transmitting unit 705 has a function of transmitting to the server 102-j, the results of disconnecting the connection between the server 102-j and the client terminal 103, the extracted backup image Bk and the update instruction for the backup image Bk.

For example, the transmitting unit 705 refers to the management table 104 and identifies the management LAN 110 IP address and netmask that corresponds to server ID “Sj” of the server 102-j. Subsequently, the transmitting unit 705 uses the identified IP address and netmask, and transmits the backup image Bk and an update instruction for the backup image Bk.

For example, the transmitting unit 705 transmits the backup image Bk to the server 102-j and as a result, the backup image Bk is stored in the server 102-j. Subsequently, the transmitting unit 705 transmits a startup instruction to the server 102-j and as a result, at the server 102-j, the backup image Bk is expanded.

After receiving from the network switch SW2, notification of completion of the disconnection of the connection between the server 102-j and the client terminal 103, the transmitting unit 705 may transmit an update instruction for the backup image Bk to the server 102-j, whereby, the update instruction can be transmitted after the connection between the server 102-j and the client terminal 103 has been surely cut.

The receiving unit 706 has a function of receiving from the server 102-j, the updated backup image Bk that has been updated at the server 102-j consequent to the transmission of the update instruction. Reception results are stored to a storage device such as the RAM 303, the magnetic disk 305, the optical disk 307, etc.

The registering unit 707 has a function of correlating and registering to the backup DB 105, the received updated backup image Bk and the server 102-i. For example, the registering unit 707 enters the updated backup image Bk to the record in the backup DB 105, corresponding to the server ID “Si” and increments the version number.

Further, the switch control unit 702 has a function of connecting the server 102-j and the client terminal 103, consequent to the registration of the updated backup image Bk. For example, the switch control unit 702 controls the transmitting unit 705 and transmits to the network switch SW2, a switching instruction to connect the server 102-j and the client terminal 103, enabling access to the server 102-j by the client terminal 103.

The switch control unit 702 has a function of connecting the information management apparatus 101 and the server 102-I, consequent to the registration of the updated backup image Bk. For example, the switch control unit 702 controls the transmitting unit 705 and transmits the network switch SW1, a switching instruction to connect the information management apparatus 101 and the server 102-i, enabling access to the server 102-i by the information management apparatus 101.

Updating work for the backup image Bk at the server 102-j may be performed automatically or manually. If performed automatically, for example, the information management apparatus 101 accesses, through the network 314, an external server that provides update data and acquires the update data for transmission to the server 102-j. The server 102-j receives from the information management apparatus 101, the update data and applies the update data to the backup image Bk.

If the updating work is performed manually, the manager of the network system 100 uses the information management apparatus 101 and transmits update data for the backup image Bk to the server 102-j. Subsequently, the server 102-j receives the update data from the information management apparatus 101 and applies the update data to the backup image Bk. The user may carry the update data stored to a recording medium and perform the work.

Although the executing agent of the software has been described to be physical servers (the servers 102-1 to 102-n), configuration is not limited hereto. For example, the executing agent may be a virtual server. In this case, the virtual server is copied or newly generated, and used as the alternative server.

A virtual server is a virtual computing device that divides resources of a physical server and operates in a built execution environment. In the case of booting from a storage area network (SAN), allocatable disks may be preliminarily registered and allocated as alternative server disks.

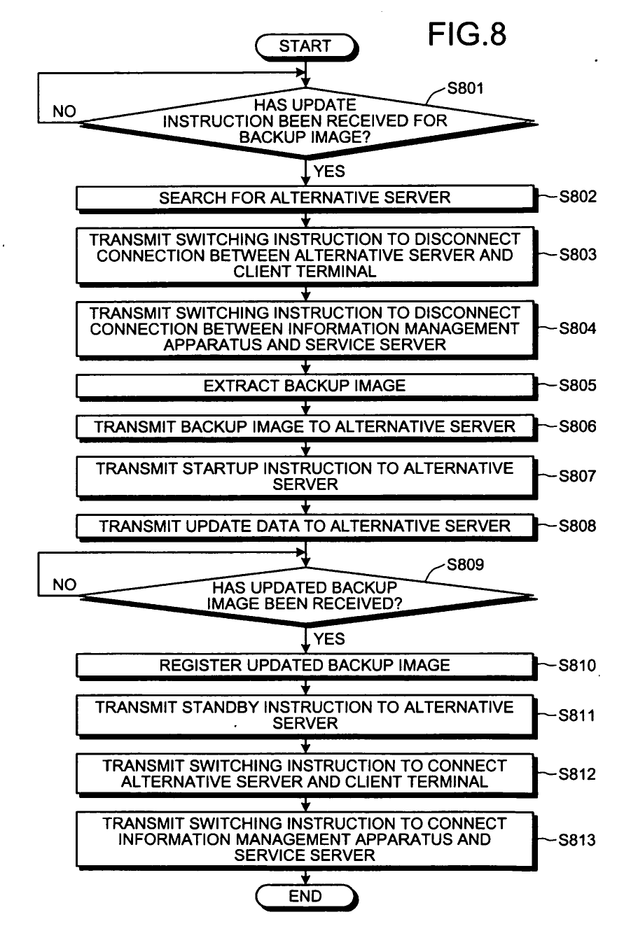

FIG. 8 is a flowchart of an updating procedure performed by the information management apparatus according to the first embodiment. In the drawings, a server 102-i in which software that is to be updated is installed is indicated as a “service server”. Further, a server 102-j that alternatively backs up the software installed in the server 102-i is indicated as an “alternative server”.

As depicted in the flowchart of FIG. 8, the receiver 701 determines whether an update instruction has been received for the backup image Bk of software installed in the server 102-i (step S801).

Here, the information management apparatus waits until an update instruction for the backup image Bk is received (step S801: NO) and when an update instruction is received (step S801: YES), the searching unit 703 searches for a server 102-j that can alternatively update the software installed in the server 102-i (step S802).

The switch control unit 702 controls the transmitting unit 705 and transmits to the network switch SW2, a switching instruction to disconnect the connection between the retrieved server 102-j and the client terminal 103 (step S803). Further, the switch control unit 702 controls the transmitting unit 705 and transmits to the network switch SW1, a switching instruction to disconnect the connection between the information management apparatus 101 and the server 102-i (step S804).

Subsequently, the extracting unit 704 extracts from the backup DB 105, the backup image Bk of the software for which the update instruction was received (step S805). The transmitting unit 705 transmits the extracted backup image Bk to the server 102-j (step S806) and further transmits a startup instruction to the server 102-j (step S807).

The transmitting unit 705 transmits update data for the backup image Bk to the server 102-j (step S808). Subsequently, the receiving unit 706 determines whether the updated backup image Bk has been received from the server 102-j (step S809).

Here, the information management apparatus waits until the updated backup image Bk has been received (step S809: NO) and when the updated backup image Bk is received (step S809: YES), the registering unit 707 correlates the updated backup image Bk with the server ID “Si” and registers the updated backup image Bk to the backup DB 105 (step S810).

The transmitting unit 705 transmits a standby instruction to the server 102-j (step S811). As a result, in the management table 104, the mode field of the server 102-j is changed from “substituting” to “standby”.

Subsequently, the switch control unit 702 controls the transmitting unit 705 and transmits to the network switch SW2, a switching instruction to connect the server 102-j and the client terminal 103 (step S812). The switch control unit 702 further controls the transmitting unit 705 and transmits to the network switch SW1, a switching instruction to connect the information management apparatus 101 and the server 102-i (step S813), ending a series of processes according to the flowchart.

As described, according to the first embodiment, when software running on the server 102-i is updated, the backup image Bk can be updated and collected at another server 102-j, to which access from the client terminal 103 is restricted. Consequently, the collision of IP addresses can be prevented during backup image Bk update using the alternative server, enabling safe backup in the latest state.

Further, according to the first embodiment, during backup image Bk update, access of the information management apparatus 101 and of the server 102-i can be disabled, whereby IP address collisions during distribution of update data for the backup image Bk to the server 102-j can be prevented.

Additionally, according to the first embodiment, based on the respective operation states of the servers 102, a server 102-j is searched for that can update the software installed in the server 102-i. Consequently, a server 102-j other than the servers 102 used in a client service and the servers 102 alternatively performing software backup can be designated as an alternative server.

Moreover, according to the first embodiment, the server 102-j and the client terminal 103 can be connected consequent to registration of the updated backup image Bk, enabling recovery of a state in which the client terminal 103 can access the server 102-j.

According to the first embodiment, the information management apparatus 101 and the server 102-i can be connected consequent to registration of the updated backup image Bk, enabling recovery of a state in which the information management apparatus 101 can access the server 102-i.

In a second embodiment, a method of converting the management LAN 110 and the service LAN 120 IP addresses of an alternative server to prevent IP address collision will be described. Description and depiction in the drawings of parts of the second embodiment described in the first embodiment are omitted.

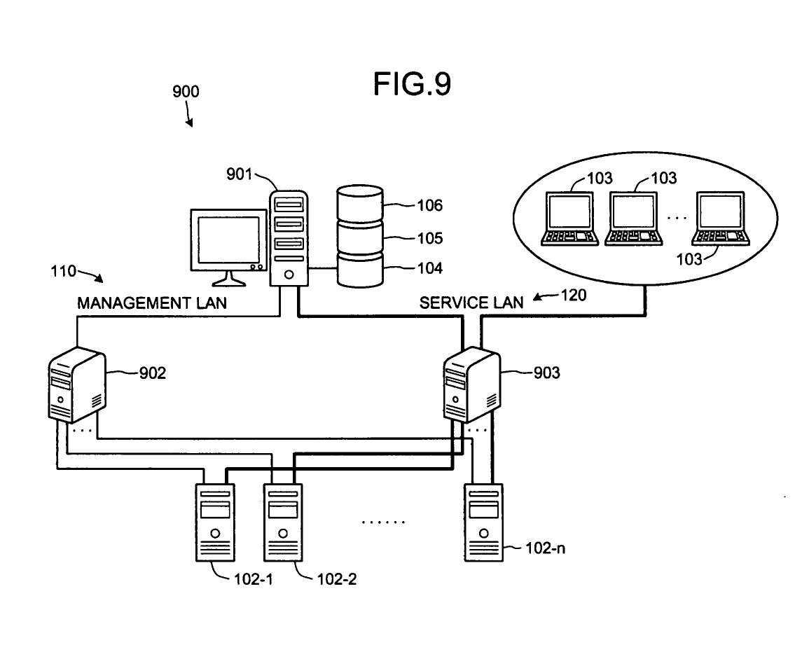

FIG. 9 is system configuration diagram of the network system according to the second embodiment. As depicted in FIG. 9, a network system 900 includes an information management apparatus 901, the servers 102-1 to 102-n, the client terminal 103, and address converting apparatuses 902, 903. In the network system 900, the information management apparatus 901, the servers 102-1 to 102-n, the client terminal 103, and the address converting apparatuses 902, 903 are connected through a network such as the management LAN 110 and the service LAN 120.

For example, the information management apparatus 901 and the servers 102-1 to 102-n are connected through the address converting apparatus 902 of the management LAN 110 to be able to mutually communicate. Further, the information management apparatus 901, the servers 102-1 to 102-n, and the client terminal 103 are connected through the address converting apparatus 903 of the service LAN 120 to be able to mutually communicate.

In this example, the address converting apparatuses 902, 903 have a switching function and a network address translation (NAT) function. The NAT function, for example, is a function of converting the IP addresses of the servers 102-1 to 102-n to other IP addresses.

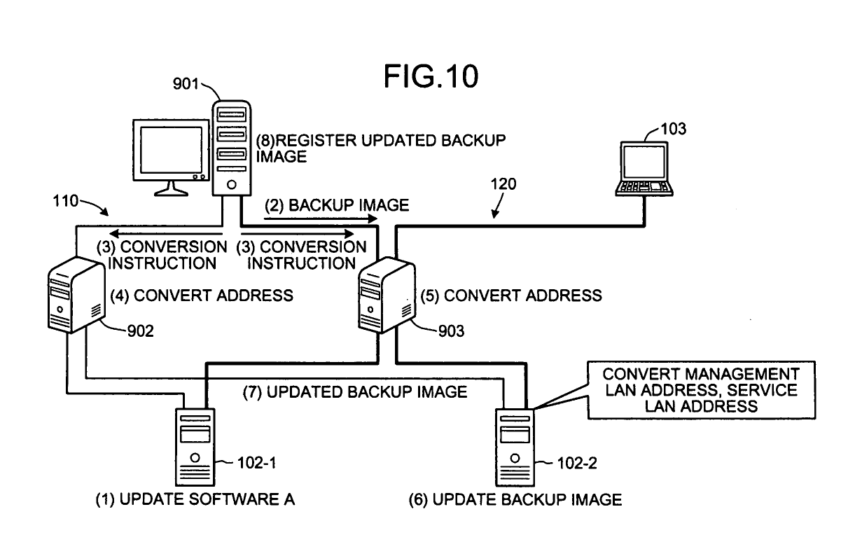

FIG. 10 is a diagram of an overview of the second embodiment. Here, it is assumed that the backup image of the software A installed in the server 102-1 is to be updated using the server 102-2.

(1) The server 102-1 updates the running software A to the latest state. As a result, a difference arises between the backup image of the software A before updating and the updated software A.

(2) Upon receiving an update instruction for the backup image of the software A, the information management apparatus 901 transmits the backup image of the software A to the server 102-2.

(3) The information management apparatus 901 transmits to the address converting apparatus 902 of the management LAN 110 and the address converting apparatus 903 of the service LAN 120, a conversion instruction for the address of the server 102-2.

(4) The address converting apparatus 902 converts the management LAN 110 address of the server 102-2 to another address. (5) The address converting apparatus 903 converts the service LAN 120 address of the server 102-2 to another address. As a result, the client terminal 103, which used the address set for the software, cannot access the server 102-2.

(6) Upon receiving a startup instruction from the information management apparatus 901, the server 102-2 updates the backup image of the software A to the latest state. (7) The server 102-2 transmits to the information management apparatus 901, the backup image of the updated software A.

(8) The information management apparatus 901 registers to the backup DB 105, the backup image of the updated software A. As a result, differences between the backup image of the software A and the software A installed in the server 102-1 are resolved.

In this manner, in the second embodiment, when the software A running on the server 102-1 is updated, at the address converting apparatus 902, the address of the server 102-2 is converted to another address and the backup image is updated and collected at the server 102-2. Consequently, address collisions occurring at the time of backup image updating using the 2 servers 102-1, 102-2 is prevented, enabling backup to be performed safely.

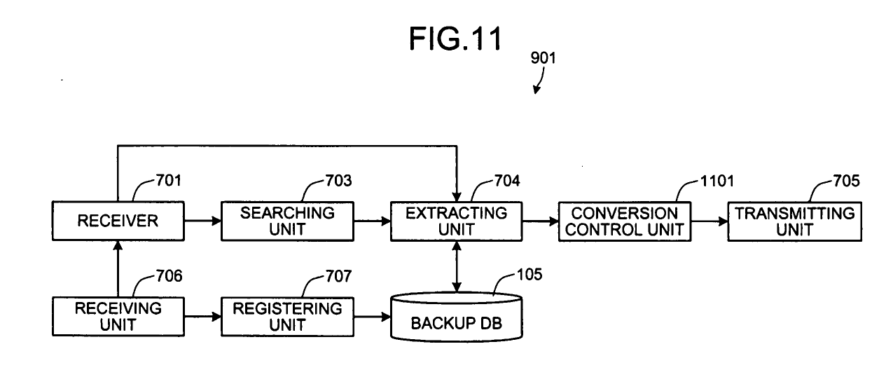

FIG. 11 is a block diagram of a functional configuration of the information management apparatus according to the second embodiment. The information management apparatus 901 includes the receiver 701, the searching unit 703, the extracting unit 704, the transmitting unit 705, the receiving unit 706, the registering unit 707, and a conversion control unit 1101.

The conversion control unit 1101 has a function of converting a first address of the server 102-j used in the communication between the server 102-j and the client terminal 103, to a second address. Here, an address is, for example, an IP address, a netmask, a MAC address, etc.

For example, the conversion control unit 1101 controls the transmitting unit 705 and transmits to the address converting apparatus 903, a conversion instruction to convert the IP address of the server 102-j to another IP address. Here, another IP address is an IP address having a 1-to-1 correspondence with the IP address of the server 102-j before conversion.

The conversion control unit 1101 further has a function of converting a third address of the server 102-j used in the communication between the information management apparatus 901 and the server 102-j, to a fourth address. For example, the conversion control unit 1101 controls the transmitting unit 705 and transmits to the address converting apparatus 902, a conversion instruction to convert the IP address of the server 102-j to another IP address.

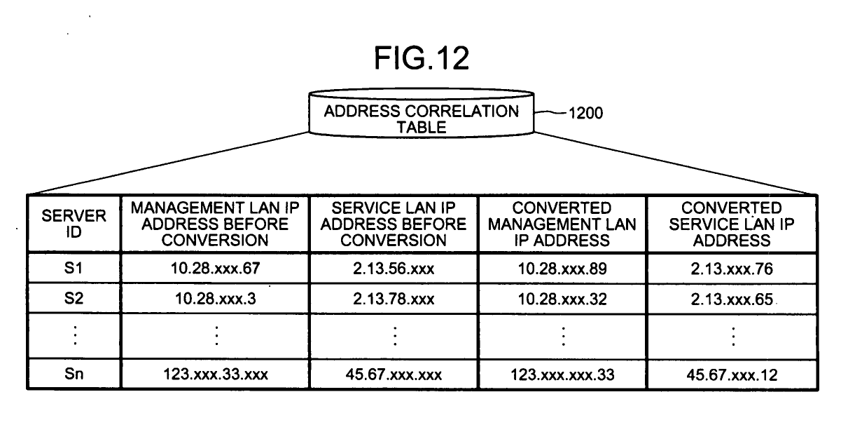

FIG. 12 is a diagram of an address correspondence table. As depicted in FIG. 12, an address correspondence table 1200 has fields including server ID, management LAN IP address before conversion, IP address of the service LAN before conversion, converted management LAN IP address, and converted service LAN IP address. By entering information into each of the fields, converted IP addresses are stored as records for each of the servers 102.

Here, an example of conversion of the IP address of the server 102-2 will be described. In this example, the conversion control unit 1101 refers to the address correspondence table 1200 and identifies the record that corresponds to the server ID “S2” of the server 102-2. The conversion control unit 1101 controls the transmitting unit 705, correlates and transmits to the address converting apparatus 902, the converted management LAN 110 IP address in the identified record. As a result, at the address converting apparatus 902, the management LAN 110 IP address of the server 102-2 is converted from “10.28.xxx.3” to “10.28.xxx.32”.

The conversion control unit 1101 controls the transmitting unit 705, correlates and transmits to the address converting apparatus 903, the converted service LAN 120 IP address in the identified record. As a result, at the address converting apparatus 903, the service LAN 120 IP address of the server 102-2 is converted from “2.13.78.xxx” to “2.13.xxx.65. The address correspondence table 1200 is stored in a storage device, such as the ROM 302, the RAM 303, the magnetic disk 305, the optical disk 307, etc.

In returning to the description of FIG. 11, the conversion control unit 1101 has a function of converting the second address of the server 102-j to the first address, consequent to the updated backup image Bk being registered to the backup DB 105. For example, the conversion control unit 1101 controls the transmitting unit 705 and transmits to the address converting apparatus 903, a deletion instruction to delete the converted IP address of the server 102-j, enabling the server 102-j to be accessed using the preconversion service LAN 120 IP address.

The conversion control unit 1101 has a function of converting the fourth address of the server 102-j to the third address, consequent to the updated backup image Bk being registered to the backup DB 105. For example, the conversion control unit 1101 controls the transmitting unit 705 and transmits to the address converting apparatus 902, a deletion instruction to delete the converted IP address of the server 102-j, enabling the server 102-j to be accessed using the preconversion management LAN 110 IP address.

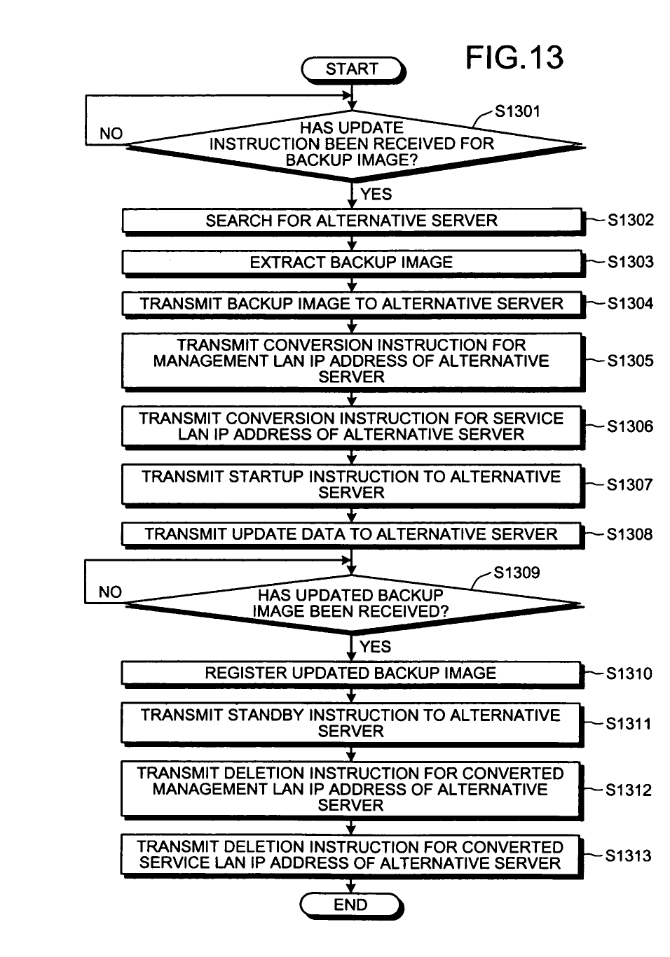

FIG. 13 is flowchart of an updating procedure performed by the information management apparatus according to the second embodiment. In the drawings, a server 102-i in which software that is to be updated is installed is indicated as a “service server”. Further, a server 102-j that alternatively backs up the software installed in the server 102-i is indicated as an “alternative server”.

As depicted in the flowchart of FIG. 13, the receiver 701 determines whether an update instruction for the backup image Bk of software installed in the server 102-i has been received (step S1301).

Here, the information management apparatus waits until an update instruction for the backup image Bk is received (step S1301: NO) and when an update instruction is received (step S1301: YES), the searching unit 703 searches for a server 102-j that can alternatively update the software installed in the server 102-i (step S1302).

Subsequently, the extracting unit 704 extracts from the backup DB 105, the backup image Bk of the software for which the update instruction was received (step S1303). The transmitting unit 705 transmits the extracted backup image Bk to the server 102-j (step S1304).

The conversion control unit 1101 refers to the address correspondence table 1200 to control the transmitting unit 705 and transmit to the address converting apparatus 902, a conversion instruction to convert the management LAN 110 IP address of the server 102-j to another IP address (step S1305). The conversion control unit 1101 further refers to the address correspondence table 1200 to control the transmitting unit 705 and transmit to the address converting apparatus 903, a conversion instruction to convert the service LAN 120 IP address of the server 102-j to another IP address (step S1306).

Subsequently, the transmitting unit 705 transmits a startup instruction to the server 102-j (step S1307) and further transmits to the server 102-j, update data for the backup image Bk (step S1308). The receiving unit 706 determines whether the updated backup image Bk has been received from the server 102-j (step S1309).

Here, the information management apparatus waits until the updated backup image Bk is received (step S1309: NO) and when the updated backup image Bk is received (step S1309: YES), the registering unit 707 correlates the updated backup image Bk with server ID “Si” and registers the updated backup image Bk to the backup DB 105 (step S1310).

The transmitting unit 705 transmits a standby instruction to the server 102-j (step S1311). As a result, in the management table 104, the mode field of the server 102-j is changed from “substituting” to “standby”.

Subsequently, the conversion control unit 1101 controls the transmitting unit 705 and transmits to the address converting apparatus 902, a deletion instruction to delete the converted management LAN 110 IP address of the server 102-j (step S1312). The conversion control unit 1101 controls the transmitting unit 705 and transmits to the address converting apparatus 903, a deletion instruction to delete the converted service LAN 120 IP address of the server 102-j (step S1313), ending a series of processes according to the flowchart.

As described, according to the second embodiment, when the backup image Bk is updated, the service LAN 120 IP address of the server 102-j is converted, disabling communication between the server 102-j and the client terminal 103. As a result, IP address collision during backup image Bk updating that uses an alternative server can be avoided.

According to the second embodiment, conversion of the management LAN 120 IP address of the server 102-j, enables IP address collision to be prevented during the distribution of update data for the backup image Bk to the server 102-j.

According to the second embodiment, when the backup image Bk is being updated, the converted IP address can be used to access the server 102-j, whereby the manager of the network system 900 can use the converted IP address on the service LAN 120 and confirm the operation of the updated software.

An example of the first embodiment will be described. In the example, a method will be described that has minimal impact on services and safely updates software that may include software that requires restarting after updating to improve function, correct bugs, etc.

For example, software running on the service server is preliminarily updated at the alternative server and registered in the backup DB 105. During a given interval when the client service can be suspended, the updated backup image Bk is used and the software installed in the service server is updated.

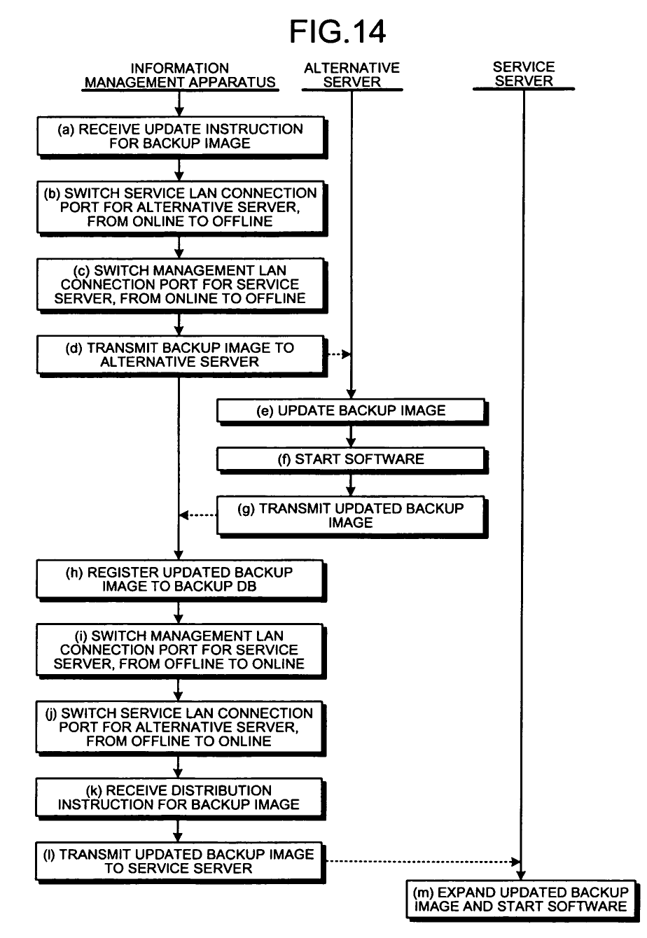

A software updating procedure will be described. Parts described and depicted in the first and the second embodiments will not be again described or depicted. FIG. 14 is a sequence diagram of an example of a software updating procedure.

(a) The information management apparatus 101 receives an update instruction for the backup image of software running on the service server. (b) The information management apparatus 101 switches the service LAN 120 connection port for the alternative server, from online to offline.

(c) The information management apparatus 101 switches the management LAN 110 connection port for the service server from online offline. (d) The information management apparatus 101 extracts from the backup DB 105, the backup image that is to be backed up and transmits the backup image to the alternative server.

(e) The alternative server updates the backup image consequent to a user input operation. (f) The alternative server expands the updated backup image and starts the software consequent to a user input operation. Here, if the user confirms the operation of the software and there is a problem, the procedure returns to (e). (g) The alternative server transmits the updated backup image to the information management apparatus 101.

(h) The information management apparatus 101 acquires the updated backup image from the alternative server and registers the updated backup image to the backup DB 105. (i) The information management apparatus 101 switches the management LAN 110 connection port of the service server, from offline to online. (j) The information management apparatus 101 switches the service LAN 120 connection port of alternative server from offline to online.

(k) The information management apparatus 101 receives a distribution instruction for the backup image. (l) The information management apparatus 101 extracts the updated backup image from the backup DB 105 and transmits the backup image to the service server.

(m) The service server expands the updated backup image and starts the software consequent to a user input operation. Here, if the user confirms the operation of the software and there is a problem, the procedure returns to (m). Nonetheless, the processes (k) to (m) are performed during the given interval when the client service can be suspended.

In this manner, according to the example, the backup image of software can be updated in advance at an alternative server to which access from the client terminal 103 is restricted. Further, during a given interval when client service can be suspended, the software installed in the service server can be updated using the updated backup image.

Consequently, even if the software has to be restarted after updating, the software can be safely updated with minimal impact on client service. Further, since the confirmation of operation is completed with the updating of the backup image, software updating work at the service server can be reduced. In the updating work at the service server, by performing the work in the same sequence as at the alternative server, trouble can be prevented from occurring, improving safety.

In the example, although description has been given concerning the network system 100 according to the first embodiment, the network system 900 according to the second embodiment can be similarly applied.

The updating method described in the present embodiment may be implemented by executing a prepared program on a computer such as a personal computer and a workstation. The program is stored on a non-transitory, computer-readable medium such as a hard disk, a flexible disk, a CD-ROM, an MO, and a DVD, read out from the recording medium, and executed by the computer. The program may be a transmission medium that can be distributed through a network such as the Internet.

According to the embodiments, software backup can be performed safely without suspending operation of the software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing therein an updating program that causes a computer to execute a procedure, the computer capable of accessing a database that stores copy information used for recovering software, the copy information being correlated with a server in which the software is installed, the procedure comprising:
receiving an update instruction for copy information of software installed in a first server that is among a group of servers;
switch-controlling to disconnect a connection between a second server that is among the group of servers and a client terminal;
extracting from the database, the copy information for which the update instruction is received at the receiving;
transmitting to the second server, the extracted copy information and an update instruction for the extracted copy information, consequent to disconnection of the connection between the second server and the client terminal;
receiving from the second server, the copy information updated at the second server, consequent to transmission of the update instruction at the transmitting; and
registering to the database, the updated copy information, which has been correlated with the first server.

2. The computer-readable, non-transitory medium according to claim 1, wherein
the switch-controlling includes transmitting to a relay apparatus that relays communication between the second server and the client terminal, a switching instruction to disconnect the connection between the second server and the client terminal.

3. The computer-readable, non-transitory medium according to claim 2, wherein
the switch-controlling includes transmitting to a relay apparatus that relays communication between the computer and the first server, a switching instruction to disconnect a connection between the computer and the first server.

4. The computer-readable, non-transitory medium according to claim 2, the procedure further comprising searching the group of servers, based on each server operation state, for the second server that can update the copy information of the software installed in the first server, wherein
the switch-controlling includes transmitting to the relay apparatus that relays communication between the second server retrieved at the searching and the client terminal, the switching instruction to disconnect the connection between the second sever and the client terminal.

5. The computer-readable, non-transitory medium according to claim 1, wherein
the switch-controlling includes connecting the second server and the client terminal, consequent to registration of the updated copy information at the registering.

6. The computer-readable, non-transitory medium according to claim 5, wherein
the switch-controlling includes connecting the computer and the first server, consequent to the registration of the updated copy information.

7. A computer-readable, non-transitory medium storing therein an updating program that causes a computer to execute a procedure, the computer capable of accessing a database that stores copy information used for recovering software, the copy information being correlated with a server in which the software is installed, the procedure comprising:
receiving an update instruction for copy information of software installed in a first server that is among a group of servers;
extracting from the database, the copy information for which the update instruction is received at the receiving;
transmitting to a second server that is among the group of servers, the extracted copy information;
conversion-controlling to convert a first address of the second server, used in communication between the second server and a client terminal, to a second address;
transmitting to the second server, an update instruction for the copy information, consequent to conversion of the first address to the second address;
receiving from the second server, the copy information updated at the second server, consequent to transmission of the update instruction transmitted at the transmitting; and
registering to the database, the updated copy information, which is received at the receiving and correlated with the first server.

8. The computer-readable, non-transitory medium according to claim 7, wherein
the conversion-controlling includes transmitting to a relay apparatus that relays communication between the second server and the client server, a conversion instruction to convert the first address of the second server to the second address.

9. The computer-readable, non-transitory medium according to claim 8, wherein
the conversion-controlling includes transmitting to a relay apparatus that relays communication between the computer and the second server, a conversion instruction to convert a third address of the second server to a fourth address.

10. The computer-readable, non-transitory medium according to claim 7, the procedure further comprising searching the groups of servers, based on each server operation state, for the second server that can update the copy information of the software installed in the first server, wherein
the conversion-controlling includes converting the first address of the second server, used in communication between the second server retrieved at the searching and the client terminal, to the second address.

11. The computer-readable, non-transitory medium according to claim 7, wherein
the conversion-controlling includes converting the second address of the second server to the first address, consequent to registration of the updated copy information registered at the registering.

12. The computer-readable, non-transitory medium according to claim 7, wherein
the conversion-controlling includes converting a fourth address of the second server to a third address, consequent to registration of the updated copy information at the registering.

13. An information management apparatus comprising:
a storage device that stores copy information that is for recovering software and correlated with a server in which the software is installed;
a receiver that receives an update instruction for copy information of software installed in first server that is among a group of servers;
a switch control unit that disconnects a connection between a second server that is among the group of servers and a client terminal;
an extracting unit that extracts from contents of the storage device, the copy information for which the update instruction is received by the receiver;
a transmitting unit that transmits to the second server, the extracted copy information and an update instruction for the extracted copy information, consequent to disconnection of the connection between the second server and the client terminal;
a receiving unit that receives from the second server, the copy information updated at the second server, consequent to transmission of the update instruction by the transmitting unit; and
a registering unit that registers to a database in the storage device, the updated copy information, which has been correlated with the first server.

14. An information management apparatus comprising:
a storage device that stores copy information that is for recovering software and correlated with a server in which the software is installed;
a receiver that receives an update instruction for copy information of software installed in a first server that is among a group of servers;
an extracting unit that extracts from a database in the storage device, the copy information for which the update instruction is received by the receiver;
a first transmitting unit that transmits to a second server that is among the group of servers, the extracted copy information;
a conversion control unit that converts a first address of the second server, used in communication between the second server and a client terminal, to a second address;
a second transmitting unit that transmits to the second server, an update instruction for the copy information, consequent to conversion of the first address to the second address;
a receiving unit that receives from the second server, the copy information updated at the second server, consequent to transmission of the update instruction transmitted by the second transmitting unit; and
a registering unit that registers to the database, the updated copy information, which is received by the receiving unit and correlated with the first server.

15. An updating method, executed by a computer which comprises a controller and a storage device and capable of accessing a database that stores copy information used for recovering software and is correlated with a server in which the software is installed, the method comprising:
receiving and storing to the storage device, an update instruction for copy information of software installed in a first server that is among a group of servers;
switch-controlling by the controller, to disconnect a connection between a second server that is among the group of servers and a client terminal;
extracting from the database and storing to the storage device by the controller, the copy information for which the update instruction is received at the receiving;
transmitting to the second server by the controller, the extracted copy information and an update instruction for the extracted copy information, consequent to disconnection of the connection between the second server and the client server;
receiving from the second server and storing to the storage device, the copy information updated at the second server, consequent to transmission of the update instruction at the transmitting; and
registering to the database by the controller, the updated copy information, which has been correlated with the first server.

16. An updating method, executed by a computer which comprises a controller and a storage device and capable of accessing a database storing copy information that is used for recovering software and is correlated with a server in which the software is installed, the method comprising:
receiving an update instruction for copy information of software installed in a first server that is among a group of servers;
extracting from the database by the controller, the copy information for which the update instruction is received at the receiving;
transmitting by the controller and to a second server that is among the group of servers, the extracted copy information;
conversion-controlling by the controller to convert a first address of the second server, used in communication between the second server and a client terminal, to a second address;
transmitting to the second server by the controller, an update instruction for the copy information, consequent to conversion of the first address to the second address;
receiving from the second server and storing to the storage device, the copy information updated at the second server, consequent to transmission of the update instruction transmitted at the transmitting; and
registering to the database by the controller, the updated copy information, which is received at the receiving and correlated with the first server.
